(19) United States
(12) Patent Application Publication
(10) Pub. No.: US 2025/0346064 A1
(43) Pub. Date: Nov. 13, 2025

(54) PAINT TRAY WITH LOCKING ARM SUPPORT

(71) Applicant: David Kropacek, Hamilton (CA)

(72) Inventor: David Kropacek, Hamilton (CA)

(21) Appl. No.: 18/656,772

(22) Filed: May 7, 2024

(51) Int. Cl. B44D 3/12

(52) U.S. Cl. CPC B44D 3/126; B44D 3/123

(57) ABSTRACT

A paint tray assembly that is configured to receive and support a roller brush handle wherein the present invention includes a support member operably coupled to a tray member wherein the support member has an articulating arm member operably coupled thereto. The present invention includes a tray member wherein the tray member has a mounting member operably coupled to the second end thereof. A support member having a base portion and a vertical member are operably coupled to the mounting member. The vertical member includes a wall and is cylindrical in shape having an interior volume. An arm support member is mateably coupled to the vertical member having a portion thereof within the interior volume of the vertical member. The arm member support includes a pair of engagement plate members that are operable to secure a lower arm section of the articulating arm member.

### FIELD OF THE INVENTION

The present invention relates generally to painting equipment, more specifically but not by way of limitation, the present invention provides a paint tray wherein the tray includes an integrally formed support member that facilitates releasable coupling of paint roller handle support assembly. The present invention further allows changing of the paint tray liners without removal of the support member.

### BACKGROUND

Painting is one of the most commonly performed tasks in construction and remodel of all types of structures. Applying coats of paint to interior and exterior surfaces is not only performed during initial construction but also performed on a routine basis. Applying coats of paint is performed with various tools such as but not limited to spray equipment, hand brushes and roller brushes. For the latter, roller brushes as is known in the art are cylindrical brushes mounted to a rolling support device and are operable to be rolled across a surface depositing paint thereon. When utilizing a roller brush it is most common to employ the use of a paint tray wherein the paint tray is configured to receive a volume of paint therein. During use, an individual will load the roller brush with paint by manipulating the roller brush into the paint in the paint tray and roll therein to allow the roller brush to absorb some of the paint.

Many individuals utilizing paint trays will insert a liner into the tray. The liner allows for rapid changing of colors and further facilitates improved cleaning of the paint tray. Most often roller brushes are utilized with long handles so as to facilitate the ability to pant in higher locations without the need for ladders or other similar equipment. The roller handles are typically five feet in length and there are commonly available support arms that attach to the paint trays and provide a technique to support the roller handle in an upright position. The problem with existing technology is the roller handle support arms also engage the paint tray liners. In order to change the liner, a user must completely remove the roller handle support arm which can be quite cumbersome. Another issue with the existing roller handle support arms is their position results in the deposit of paint thereon. As paint deposits onto the lower portion of the roller support arms, the mechanism to attach and release the support arm becomes more difficult to operate and ultimately can become unusable due to coats of dried paint thereon.

Accordingly, there is a need for a paint tray assembly that provides an integrally formed roller handle support assembly that does not interfere with liner replacement and further includes an articulating arm member for support of roller brush handles.

### SUMMARY OF THE INVENTION

It is the object of the present invention to provide a paint tray assembly that is configured to provide support of a roller brush handle wherein the present invention includes a tray member.

Another object of the present invention is to provide a paint tray assembly configured to support a roller brush handle and liner replacement wherein the tray member has a support member operably coupled to the second end of the tray member.

A further object of the present invention is to provide a paint tray assembly that is configured to provide support of a roller brush handle wherein the support member includes a base portion that is planar in manner.

Yet a further object of the present invention is to provide a paint tray assembly configured to support a roller brush handle and liner replacement wherein the base portion includes a vertical member extending upward therefrom.

Still another object of the present invention is to provide a paint tray assembly that is configured to provide support of a roller brush handle wherein the vertical member of the support member has an articulating arm member operably coupled thereto.

An additional object of the present invention is to provide a paint tray assembly configured to support a roller brush handle and liner replacement wherein the articulating arm member includes three movable sections.

Yet a further object of the present invention is to provide a paint tray assembly that is configured to provide support of a roller brush handle wherein the vertical member includes an arm support member operably coupled thereto.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a rear perspective view of the present invention; and

FIG. 2 is a top view of the present invention; and

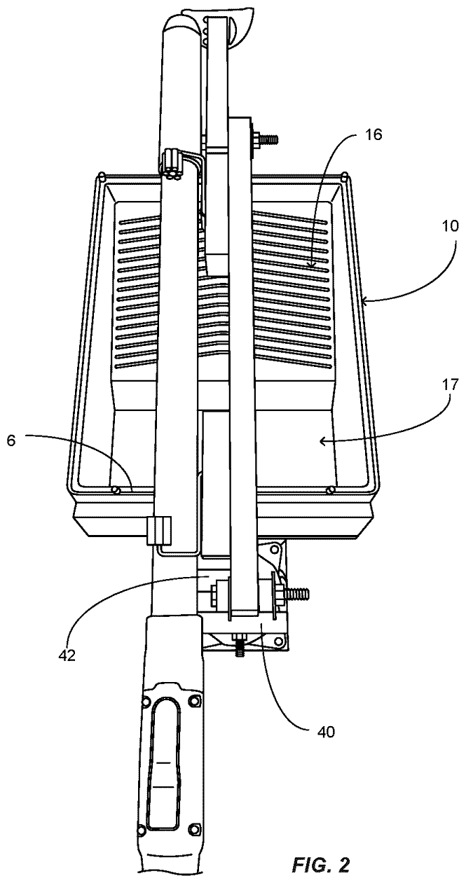

FIG. 3 is a front perspective view with the arm member deployed; and

FIG. 4 is a detailed view of the support member of the present invention.

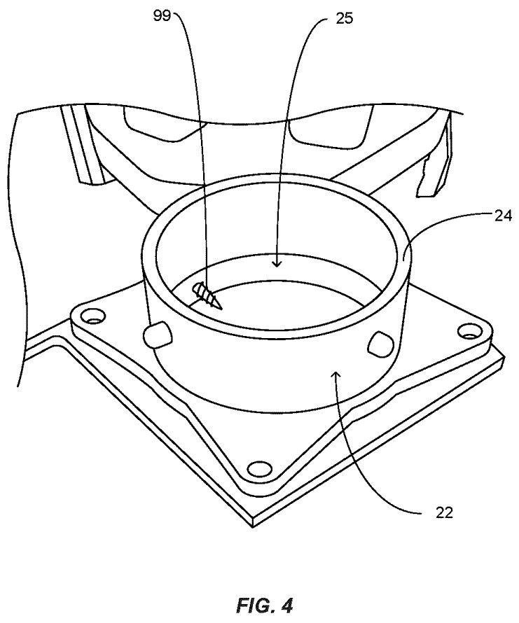

### DETAILED DESCRIPTION

Referring now to the drawings submitted herewith, wherein various elements depicted therein are not necessarily drawn to scale and wherein through the views and figures like elements are referenced with identical reference numerals, there is illustrated a paint tray assembly 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Referring in particular to the Figures submitted herewith, the paint tray assembly 100 includes tray member 10. Tray member 10 is manufactured from a durable material such as but not limited to plastic or metal. Tray member 10 includes a first end 11 and second end 12. A plurality of walls 13 integrally formed with a bottom 14 define the interior volume 15 of the tray member 10. The bottom 14 of the tray member 10 includes a first section 16 and a second section 17 wherein the first section 16 is angled downwards into the second section 17 with the second section 17 having more volume to receive and store paint therein. It should be understood within the scope of the present invention that the tray member 10 could be provided in alternate sizes and shapes.

Operably coupled to the second end 12 of the tray member 10 is support member 20. Support member 20 includes a base portion 21 and a vertical member 22. The base portion 21 is planar in manner being square in shape having an upper surface 23. The base portion 21 is manufactured from a suitable rigid material such as but not limited to plastic or metal. Formed with the base portion 21 extending upward from the upper surface 23 is the vertical member 22. The vertical member 22 is perpendicular to the base portion 21 and is cylindrical in shape having wall 24. The wall 24 forms interior volume 25 wherein the interior volume 25 is configured to have the arm support member 30 operably disposed therein ensuing coupling of the support member 20 and arm support member 30. Support member 20 is operably coupled to the tray member 10 utilizing mounting member 80. Mounting member 80 is secured to the second end 12 of the tray member 10 utilizing suitable techniques. Mounting member 80 is manufactured from a durable rigid material and is provided in a thickness that is at least three times the thickness of wall 24 in order to provide the necessary structural support for the support member 20. Mounting member 80 extends substantially across the width of the rear wall 6.

Arm support member 30 includes portion 31 that is mateable in shape to the interior volume 25 and is operable to be inserted thereinto. It is contemplated within the scope of the present invention that the vertical member 22 could be provided in a first embodiment and a second embodiment. The first embodiment includes slots 29 formed in the wall 24 wherein the slots 29 are operable to receive locking tabs (not particularly illustrated herein) formed on portion 31. The tabs operably couple with the slots 29 to releasably secure the arm support member 30 with the support member 20. A second embodiment of the vertical member 22 employs utilization of fasteners 99 that are journaled through the wall 24 so as to secure portion 31 within the interior volume 25 of the vertical member 22.

The arm support member 30 further includes engagement plate members 40,42 superposed the portion 31. The engagement plate members 40,42 are secured to the upper surface of the portion 31 having a void therebetween that is operable to have lower arm section 50 secured therebetween. The engagement plate members 40,42 have fastener 46 operably coupled thereto wherein the fastener 46 is configured to bias the engagement plate members 40,42 towards each other securing the lower arm section 50 therebetween. It is contemplated within the scope of the present invention that the lower arm section 50 could be operably coupled to the portion 31 utilizing alternate elements and/or techniques in addition to or in combination with the engagement plate members 40,42.

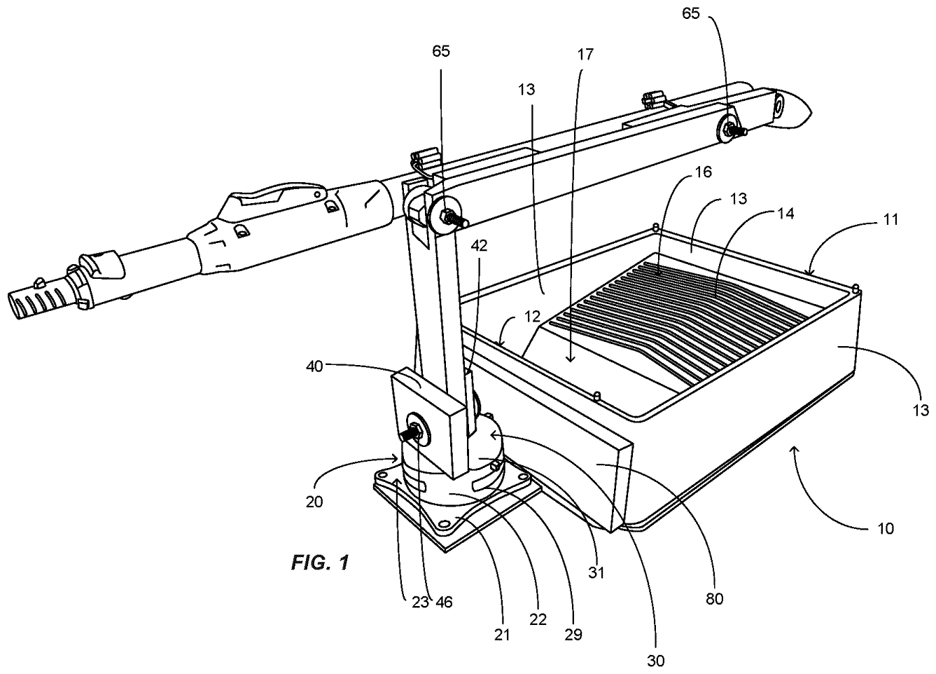

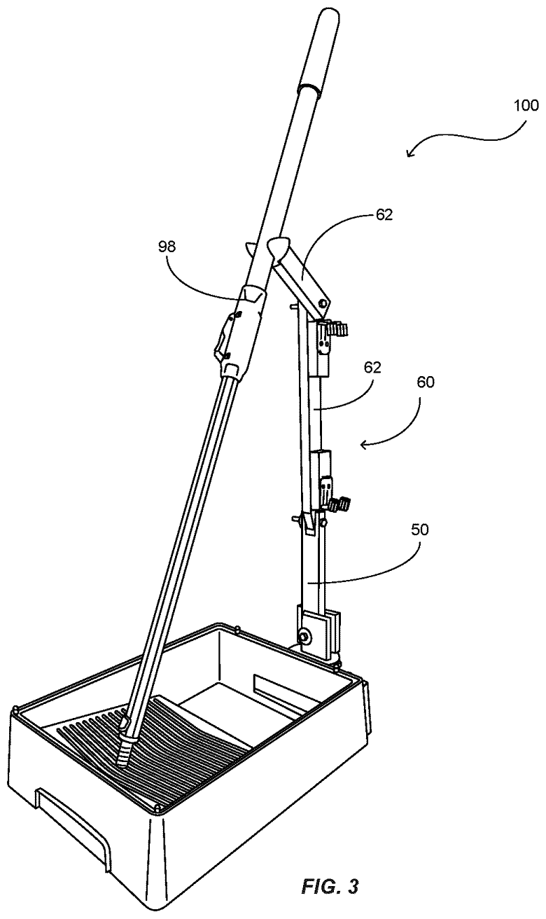

The paint tray assembly 100 includes an articulating arm member 60. The articulating arm member 60 is configured to be moved from a stored position, illustrated herein in FIG. 1, to a deployed position illustrated herein in FIG. 3. In the deployed position of the articulating arm member 60 is operable to receive a conventional roller brush handle 98 and provide support thereof. The articulating arm member 60 is comprised of a plurality of sections 62 that are pivotally coupled with respect to each other utilizing fasteners 65 and can each be manipulated at least ninety degrees with respect to the adjacent section 62. It is contemplated within the scope of the present invention that the sections 62 could be provided in various lengths. Furthermore, it is additionally contemplated within the scope of the present invention that the articulating arm member 60 could be comprised of alternate quantities of sections 62.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A paint tray assembly that is configured to receive and support a roller brush handle wherein the paint tray assembly comprises:
a tray member, said tray member having a bottom and plurality of walls formed to create an interior volume, said bottom of said tray member having a first section and a second section, said tray member having a first end and a second end;
a mounting member, said mounting member being secured to the second end of said tray member, said mounting member being adjacent a rear wall of the tray member, said mounting member extending across said rear wall, said mounting member having a thickness that is greater than a thickness of said rear wall;
a support member, said support member being operably coupled to said mounting member opposite said rear wall, said support member having a base portion, said support member having a vertical member extending upward from an upper surface of said base portion, said vertical member being cylindrical in shape having an outer wall, said vertical member having an interior volume;
an arm support member, said arm support member having a portion that is mateable in shape to said interior volume of said support member, said portion of said arm support member configured to be mateably coupled to said vertical member; and
an articulating arm member, said articulating arm member being operably coupled to said arm support member, said articulating arm member configured to be moved between a stored position and a deployed position.

2. The paint tray assembly that is configured to receive and support a roller brush handle as recited in claim 1, wherein said arm support member further includes a pair of engagement plate members, said engagement plate members being operably coupled to an upper surface of the portion of the arm support member.

3. The paint tray assembly that is configured to receive and support a roller brush handle as recited in claim 2, wherein the engagement plate members have a void therebetween wherein a lower arm section of the articulating arm member is biased therebetween.

4. The paint tray assembly that is configured to receive and support a roller brush handle as recited in claim 3, wherein said articulating arm member includes three sections pivotally coupled.

5. The paint tray assembly that is configured to receive and support a roller brush handle as recited in claim 4, wherein said outer wall of said vertical member further includes slots formed therein, said slots configured to operably couple with said portion of said arm support member.

6. The paint tray assembly that is configured to receive and support a roller brush handle as recited in claim 4, wherein said mounting member has a thickness three times the thickness of said rear wall.

7. The paint tray assembly that is configured to receive and support a roller brush handle as recited in claim 6, wherein each section of said articulating arm member is movable at least ninety degrees with respect to an adjacent section.

8. The paint tray assembly that is configured to receive and support a roller brush handle as recited in claim 7, wherein in said stored position said lower arm section of the articulating arm member extends outward from said support member and said three sections are adjacent each other being perpendicular to said lower arm section.
